(19) United States
(12) Patent Application Publication
(10) Pub. No.: US 2013/0015133 A1
(43) Pub. Date: Jan. 17, 2013

(54) SYSTEM AND METHOD FOR THE REDUCTION OF VOLATILE ORGANIC COMPOUND CONCENTRATION IN WATER USING PRESSURIZED DIFFUSED AERATION

(71) Applicants: Ethan Brooke, Biddeford, ME (US); Michael Robin Collins, Lee, NH (US); John Michael Zwerneman, Dallas, TX (US)

(72) Inventors: Ethan Brooke, Biddeford, ME (US); Michael Robin Collins, Lee, NH (US); John Michael Zwerneman, Dallas, TX (US)

(21) Appl. No.: 13/398,622

(22) Filed: Feb. 16, 2012

Related U.S. Application Data
(63) Continuation-in-part of application No. 13/135,666, filed on Jul. 12, 2011.

(51) Int. Cl. C02F 1/20; B01F 3/04; C02F 101/30

(52) U.S. Cl. 210/640; 210/218; 261/119.1; 210/143; 210/750

(57) ABSTRACT

The system and method reduces volatile organic compound concentration in a water distribution system using pressurized diffused aeration. The system and method is used in-line in a water distribution system. The system and method can be used at the ends of the distribution system where volatile organic compounds, including trihalomethanes, are more likely to persist. The system and method of pressurized, diffused aeration reduces volatile organic compounds from groundwater remediation systems as well.

### CROSS-REFERENCE TO RELATED APPLICATIONS

This application is a continuation-in-part of U.S. patent application Ser. No. 13/135,666, filed on Jul. 12, 2011, which is incorporated herein by reference.

### GOVERNMENT INTEREST

This invention was made with government support for the New England Water Treatment Assistance Center with grants awarded by the United States Environmental Protection Agency. The government has certain rights in the invention.

### FIELD OF THE INVENTION

The present invention relates to the reduction of total volatile organic compound concentration in water. More particularly it relates to the reduction of total trihalomethane concentration in finished drinking water using pressurized diffused aeration.

### BACKGROUND OF THE INVENTION

Volatile Organic Compounds (VOCs) are organic chemicals that have a high vapor pressure, or volatility, at ordinary, room-temperature conditions. Their volatility results from a low boiling point, which causes large numbers of molecules to evaporate or sublimate from the liquid or solid form of the compound and enter the surrounding air or water. VOCs are numerous, varied, and ubiquitous. They include both man-made and naturally occurring chemical compounds. VOCs can be present in ground water and be of environmental concern, or VOCs can be present in drinking water and be a public health issue. For example, one group of VOCs is Trihalomethanes (THMs), which are disinfection byproducts (DBPs) found in drinking water. The present invention applies to the removal of VOCs from water, in general, but for simplicity the present invention will be discussed in reference to THMs in drinking water.

Drinking water is disinfected at a drinking water treatment plant and contains residual levels of disinfectant throughout the distribution system. Because disinfectants are by nature reactive, they form disinfection byproducts, or unwanted chemicals, by reacting with natural organic matter (NOM), which is present at some level in all water. As noted in the equation below, the interaction of disinfectant (e.g. chlorine) and certain forms of NOM create DBPs. Large concentrations of NOM can result in elevated DBP levels.

Natural Organic Matter+Disinfectant+Time=DPBs

Moreover; the longer the disinfectant and the NOM are in contact within the drinking water distribution system the more DBPs are formed.

Trihalomethanes (THMs) are the most common form of DBP. THMs are chemical compounds in which a halogen atom replaces three of the four hydrogen atoms in methane (CH₄). The halogen atom may be fluorine (F), chlorine (Cl), bromine (Br), or iodine (I). The most common trihalomethanes found in a water distribution system include chloroform (CHCl₃), bromoform (CHBr₃), chlorodibromomethane (CHClBr₂), and bromodichloromethane (CHBrCl₂).

Ingestion of certain amounts of THMs can cause liver, kidney, or central nervous system problems, as well as an increased risk of cancer. See Stage 1 Disinfectants and Disinfection Byproducts Rule. 816-F-01-014. Office of Water: June 2001.

DBPs are regulated by the EPA. The EPA first regulated total trihalomethanes (TTHM) in 1979 at 100 parts per billion (ppb) for systems serving at least 10,000 people. The EPA revised this rule when it issued the Stage 1 Disinfectants and Disinfection Byproducts Rule (Stage 1 DBPR) in December of 1998. The Stage 1 DBPR was the first phase in a rulemaking strategy required by Congress as part of the 1996 Amendments to the Safe Drinking Water Act. The Stage 1 DBPR set the maximum contaminant level (MCL) for TTHM at 80 ppb. These standards had to be met by the end of 2002 for surface water systems serving 10,000 or more people and by the end of 2004 for all other systems. The Stage 2 DBPR was proposed in August 2003 and finalized on Dec. 15, 2005.

The Stage 2 DBPR applies to public water systems (PWSs) that are community water systems (CWSs), and non-transient non-community water systems (NTNCWs) that 1) add a primary or residual disinfectant other than ultraviolet light, or 2) deliver water that has been treated with a primary or residual disinfectant other than ultraviolet light. The key provision in this rule is the change in calculating the maximum contaminant level (MCL). Up to now, compliance with the MCL was calculated using a rolling annual average (RAA) to average compliance samples across the water distribution system's sampling locations. Under Stage 2 DBPR, the MCL will be calculated using locational rolling annual averages (LRAAs). PWSs must maintain the locational rolling annual average (LRAA) for each compliance sampling location at or below 80 ppb total trihalomethane (TTHM).

Meeting these regulations has been reported to cost taxpayers $700 M annually, and affect over 116 M households. See Stage 2 Disinfectants and Disinfection Byproducts Rule. 815-F-05-003. Office of Water: December 2005. With the advent of these stricter trihalomethane (THM) regulations, it is becoming increasingly important that water distribution system municipalities explore all possible avenues to reduce THMs.

Existing methods of addressing the new MCL requirements are costly and may require large capital investment. Since NOM+disinfectant+time=DBP, there are essentially four ways to reduce THM concentration. First, water distribution system municipalities could reduce the NOM levels in the water before chlorination. Second, water distribution system municipalities could switch disinfectants to less reactive forms, or to entirely new systems of disinfection, such as ozone and/or UV disinfection. These disinfection methods would require new systems to be implemented at large costs to water system providers. And, a switch to another chemical disinfectant, such as chloramine, can create new problems such as precipitation of lead or other metals; nitrification and algal growth in the distribution networks; or the creation of other DBPs. Third, efforts to reduce water age, or residence time, can be made, though due to the nature of the distribution networks, this option is often not possible, especially at the far ends of the distribution system. Fourth, the DBPs can be reduced/removed after their formation.

Currently, there are a variety of alternatives for reducing THMs to safe levels, and for maintaining disinfection standards; however, many of these alternatives, such as enhanced coagulation, or granular activated carbon adsorption (GAC), are costly and highly-intrusive solutions. These current methods remain out of reach for many small water distribution systems. For this reason, it is recognized that there is a need for treatment options that do not require a large capital investment for reducing THMs.

Water treatment professionals are beginning to implement non-pressurized diffused aeration systems in remote locations in the distribution system where water storage tanks exist, but systems without storage tanks in remote locations have been left with few options until now. (Applicant's own work, see U.S. patent application Ser. No. 13/135,666 published Jan. 21, 2012, claiming priority to 61/363,401; filed Jul. 12, 2010).

The method and system of the present invention focuses on the removal of THMs after their formation in a safe and cost-effective way. This approach allows water treatment plants to keep current chlorine disinfection, and make only minimal changes to the system where THM violations are present. Thus, the cost of implementation is low and there is a lower expertise requirement. This approach can also be implemented at any point in the distribution system, so it can help focus treatment where it is most needed and effective. Thus, allowing even the smallest water supply providers to comply with the new MCL requirements.

### SUMMARY OF THE INVENTION

Due to elevated residence times, trihalomethanes are often highest in remote parts of a distribution system making these the areas where they can be removed most efficiently. A system and method for the removal of THMs from water using diffused aeration under pressure and in-line within a distribution system could offer direct treatment of “hot-spots,” or areas of elevated THM concentrations, without de-pressurizing the system. This system and method would not require large capital investment.

One aspect of the present invention is a system for reducing the concentration of volatile organic compounds in water comprising, a pressurized reactor containing influent water with a first concentration of volatile organic compounds; a mechanism for introducing air into the reactor at a flow rate proportional to the influent water flow rate represented by an air-to-water ratio, thereby causing the air to flow through the influent water; and a venting system configured to release air containing volatile organic compounds from the reactor causing the air, after flowing through the influent water with a first concentration of volatile organic compounds, to escape the reactor thereby reducing the concentration of volatile organic compounds in the effluent water to a second concentration.

In one embodiment of the system for reducing the concentration of volatile organic compounds in water the reactor is a pressurized aeration reactor.

In one embodiment of the system for reducing the concentration of volatile organic compounds in water the reactor is a modified pipe in a water distribution system.

In one embodiment of the system for reducing the concentration of volatile organic compounds in water the volatile organic compound is a trihalomethane.

In one embodiment of the system for reducing the concentration of volatile organic compounds in water the mechanism for introducing air into the reactor comprises an air compressor.

In one embodiment of the system for reducing the concentration of volatile organic compounds in water the mechanism for introducing air into the reactor further comprises breaking the air flow into bubbles.

In one embodiment of the system for reducing the concentration of volatile organic compounds in water the mechanism for introducing air into the reactor comprises a diffuser.

In one embodiment of the system for reducing the concentration of volatile organic compounds in water the mechanism for introducing air into the reactor comprises a controller.

In one embodiment of the system for reducing the concentration of volatile organic compounds in water the venting system comprises an air release valve.

In one embodiment of the system for reducing the concentration of volatile organic compounds in water the venting system comprises a membrane.

In one embodiment of the system for reducing the concentration of volatile organic compounds in water the pressure in the reactor is from about 20 psi to about 120 psi.

In one embodiment of the system for reducing the concentration of volatile organic compounds in water the air-to-water ratio is from about 1 to about 150.

In one embodiment of the system for reducing concentration of volatile organic compounds in water the concentration of volatile organic compounds in the water is reduced by about 1% to about 99%.

Another aspect of the present invention is a method of reducing the concentration of volatile organic compounds in water comprising, introducing water with a first concentration of volatile organic compounds into a pressurized reactor; introducing air into the reactor at a flow rate proportional to the influent water flow rate represented by an air-to-water ratio, thereby causing the air to flow through the influent water; and releasing air from the pressurized reactor through a venting system configured to release air containing volatile organic compounds from the reactor causing the air, after flowing through the influent water with a first concentration of volatile organic compounds, to escape the reactor thereby reducing the concentration of volatile organic compounds in the effluent water to a second concentration.

In one embodiment of the method of reducing the concentration of volatile organic compounds in water the reactor is a pressurized aeration reactor.

In one embodiment of the method of reducing the concentration of volatile organic compounds in water the reactor is a modified pipe in a water distribution system.

In one embodiment of the method of reducing the concentration of volatile organic compounds in water the volatile organic compound is a trihalomethane.

In one embodiment of the method of reducing the concentration of volatile organic compounds in water the step of introducing air into the reactor comprises an air compressor.

In one embodiment of the method of reducing the concentration of volatile organic compounds in water the step of introducing air into the reactor further comprises breaking the air flow into bubbles.

In one embodiment of the method of reducing the concentration of volatile organic compounds in water the step of introducing air into the reactor comprises a diffuser.

In one embodiment of the method of reducing the concentration of volatile organic compounds in water the step of introducing air into the reactor comprises a controller.

In one embodiment of the method of reducing the concentration of volatile organic compounds in water the venting system comprises an air release valve.

In one embodiment of the method of reducing the concentration of volatile organic compounds in water the venting system comprises a membrane.

In one embodiment of the method of reducing the concentration of volatile organic compounds in water the pressure in the reactor is from about 20 psi to about 120 psi.

In one embodiment of the method of reducing the concentration of volatile organic compounds in water the air-to-water ratio is from about 1 to about 150.

In one embodiment of the method of reducing concentration of volatile organic compounds in water the concentration of volatile organic compounds in the water is reduced by about 1% to about 99%.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a diagram of a water distribution system highlighting locations where post treatment aeration systems of the present invention might be installed.

FIG. 2 shows a diagram of one embodiment of a continuous-mode pressurized aeration system.

FIG. 3 shows a diagram of one embodiment of a bench-scale batch-mode pressurized aeration system.

FIG. 4 shows a diagram of one embodiment of a bench-scale continuous-mode pressurized aeration system.

FIG. 5 shows a diagram of one embodiment of a continuous-mode pressurized aeration system.

FIG. 6 shows the effect of pressure on the % removal of individual THMs.

FIG. 7 shows the effect of pressure on the % removal of TTHMs.

FIG. 8 shows % removal of TTHMs at varied air-to-water ratios for both batch-mode and continuous-mode embodiments of the present invention.

FIG. 9 shows % removal of TTHMs at varied air flow rates and pressure for embodiments of the present invention.

FIG. 10 shows the calculated v. the reported Henry's Law constants for individual THMs.

FIG. 11 shows the calculated v. the reported Henry's Law constants for individual THMs.

### DETAILED DESCRIPTION OF THE INVENTION

Existing methods of addressing the new MCL requirements are costly and may require large capital investment. Since NOM+disinfectant+time=DBPs, there are essentially four ways to reduce THM concentration. First, water distribution system operators could reduce the NOM levels in the water. Second, water supply and treatment operators could switch disinfectants to less reactive forms, or to entirely new systems of disinfection. Third, the water age in the distribution network can be reduced. Fourth, the DBPs can be reduced/removed after their formation.

It is recognized that from an economic and an operational standpoint, the removal of THMs from a distribution system after formation would be best for some water treatment systems. The system and method of the present invention uses an in-line aeration device to reduce THM concentrations at any point in the length of a distribution system. This approach does not require water treatment facilities to make any changes to their disinfection method, and it also provides the flexibility to reduce THMs in problematic areas at remote locations within a distribution system. Additionally, the present invention allows one to model the potential reduction in TTHMs which results from pressurized in-line aeration devices, to present water service providers with the necessary tools to achieve compliance with the new MCLs for THMs.

Other methods of addressing the new MCL requirements are costly and may require large capital investment. Referring back to the equation NOM+disinfectant+time=DPBs, we see that one alternative would be to try to reduce the NOM levels in the water. This would require the treatment of the entire volume of water required for a treatment system, and may require costly additional systems to be installed, such as ozone-biofiltration systems; anionic exchange resin systems; enhanced coagulation systems; granular activated carbon systems; or nano or reverse osmosis systems at additional capital expense.

Another option for addressing the new MCL requirements would be to switch disinfectants to less reactive forms, or to entirely new systems of disinfection, such as ozone and/or UV disinfection. These disinfection methods would require new systems which would treat the entire volume of water required for a treatment system, implemented at large costs to water providers. A switch to another chemical disinfectant, such as chloramine could create additional problems such as precipitation or lead and other metals, or nitrification in the distribution system causing algal growth, or the presence of additional DBPs. Though chloramine may be less likely to form DBPs, this may be due to the lack of research on DBPs associated with chloramine. The use of chloramine raises other concerns as well, such as the formation of carcinogens, and environmental toxicity.

The method and system of the present invention focuses on the removal of VOCs, especially THMs after their formation in a safe and cost-effective way. This approach allows water treatment plants to keep current chlorine disinfection, and make only minimal changes to the system. One significant benefit of this technology is that the volume of water treated may be significantly less than that associated with other treatment options to reduce THMs. Thus, the cost of implementation is low and there is a lower expertise requirement. This approach can also be implemented at any point in the distribution system, so it can help locus treatment where it is most needed. Alternatively, this approach can be used to complement other systems where the removal of TTHMs is more burdensome.

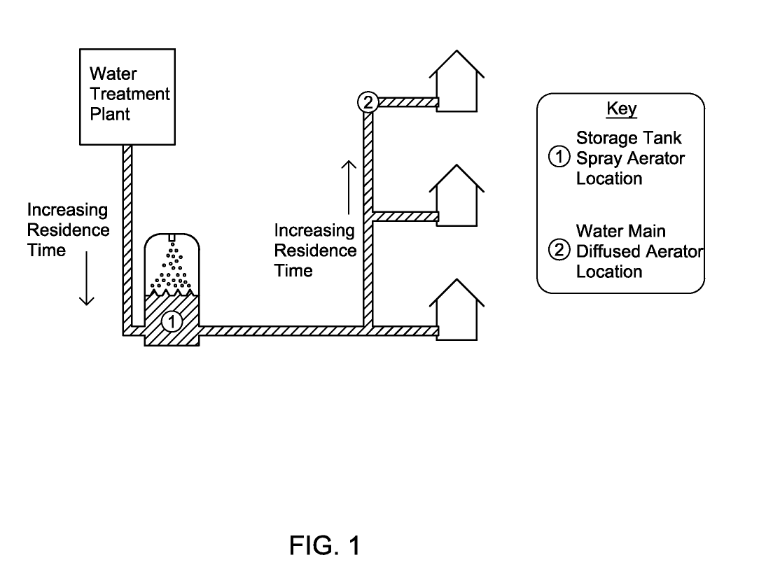

FIG. 1 shows a water distribution system for a small town. As water travels through the water distribution network, DBPs are formed. Aeration site #1 is inside a water storage tank (Applicant's own work, see U.S. patent application Ser. No. 13/135,666 published Jan. 21, 2012, claiming priority to 61/363,401; filed Jul. 12, 2010). Aeration site #2 is at the end of the water distribution system, where maximum residence times and the highest THM concentrations are commonly noted.

These area “hotspots” at the ends of the water distribution network can create a singular THM violation. In order to address the violation, municipalities often remove THMs by treating water at the water treatment plant to a higher standard, at a much greater cost. By creating a treatment option that can be installed farther out in the distribution network where violations commonly occur, a unique and inexpensive approach to combating DBP violations is readily available especially when compared to changing the proven disinfection regime, or adding a treatment process in the water treatment plant that would treat a large water volume.

THMs are a form of volatile organic compound (VOC). VOCs are organic chemicals that have a high vapor pressure at ordinary, room-temperature conditions. Thus, the Henry's Law Constant for each of the VOCs is an important factor to consider when designing a system or method for removing VOCs from solution. Henry's Law states that at a constant temperature, the amount of a given gas that dissolves in a given type and volume of liquid is directly proportional to the partial pressure of that gas in equilibrium with that liquid. In other words, the solubility of a gas in a liquid at a particular temperature is proportional to the pressure of that gas above the liquid. The Henry's Law Constant (H) used in designing the diffused aeration system is dimensionless, see the equation below:

H=Ci,Gas/Ci,Liquid

Diffused aeration can be used as a method to remove water contaminants that are prone to volatilization, which is the transfer from an aqueous to a gaseous phase. By creating contact between air and aqueous volatile contaminants, the volatile contaminants will be transferred from the water to the air and carried out of the water as the bubbles rise to the surface and enter the atmosphere. The goal of diffused aeration is to provide an air-to-water ratio such that the effluent air is capable of being saturated with the VOC, maximizing VOC removal. Air-to-water ratio is represented by air flow rate×time/water volume for batch systems; and air flow rate/water flow rate for continuous systems.

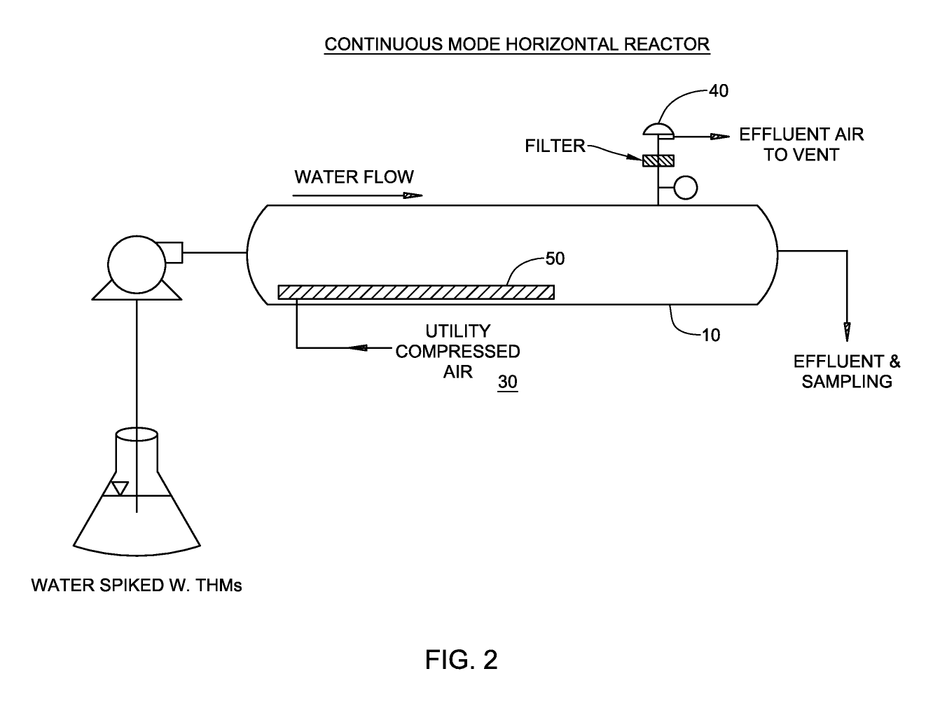

FIG. 2 is a diagram of components of a continuous-mode pressurized diffused aeration system. Other features of a continuous pressurized diffused aeration system could include one or more of the following: flow meters, an air compressor, valves, venting systems, nano or reverse osmosis membranes, an air diffuser, baffles, controllers, and a housing for the apparatus. The water with VOC (e.g. THM) levels before reduction is shown flowing through the system (e.g. a tank 10) and the VOCs are removed from the pressurized system via the introduction of air into the system 30 in the form of air bubbles using a diffuser stone 50. The pressure of the system, P, is determined by the ambient pressure of the distribution system. The air that has been introduced by the compressor is then released from the system via a venting system 40, such as an air release valve, a membrane, or a combination, taking the VOCs with it.

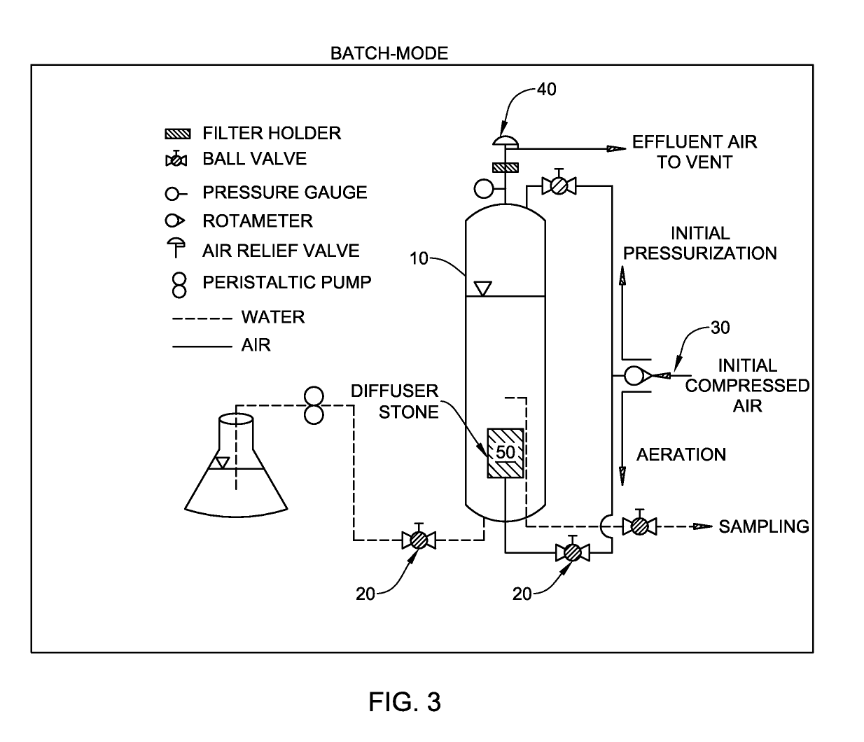

FIG. 3 is a schematic of a bench-scale batch-mode pressurized diffused aeration system. The batch-mode apparatus contains a tank 10, ball valves 20, a source of compressed air 30, a venting system 40, and a diffuser 50, or a network of diffusers. The batch-mode system treats one volume of water at a time and is amenable to study in the laboratory. Experiments with the apparatus in the laboratory have shown the effect of system pressure, air flow rate, and aeration time on the removal of volatile contaminants in water, specifically THMs.

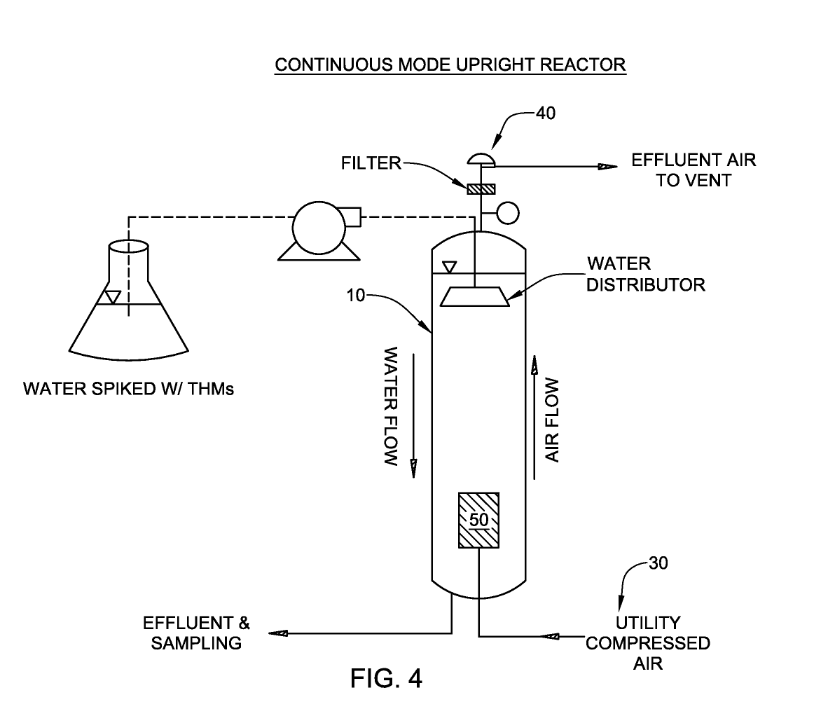

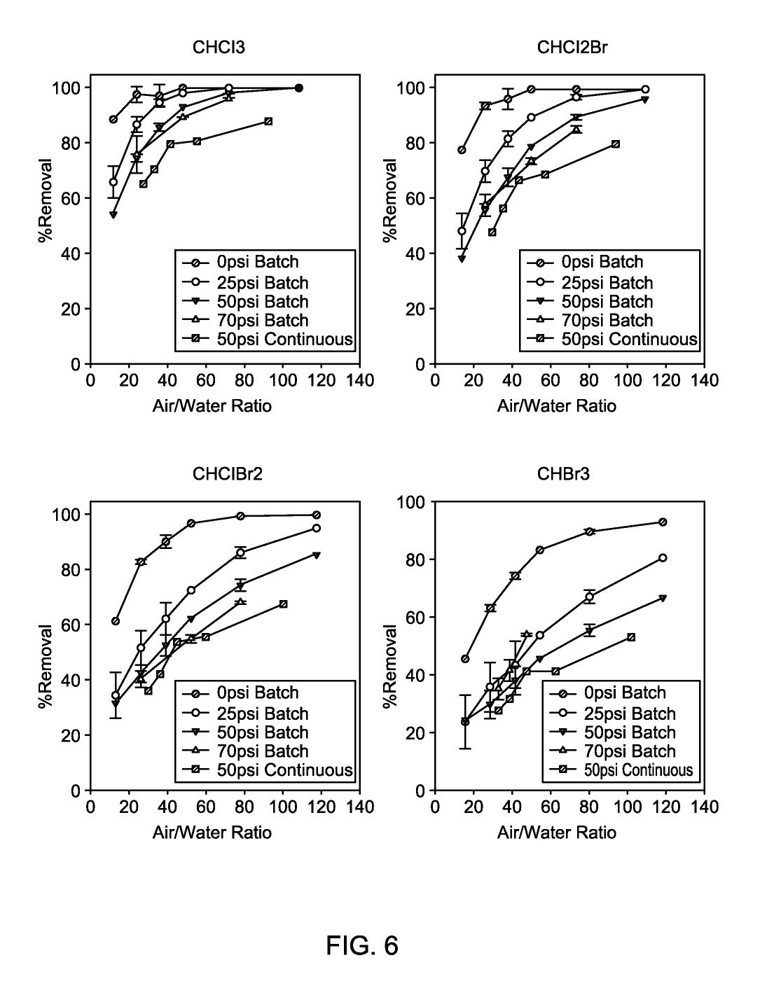

Referring to FIG. 4, the upright, continuous-mode pressurized aeration system contains a tank 10, a source of compressed air 30, a venting system 40, and a diffuser 50 or a network of diffusers. The prototype apparatus was operated at air-to-water ratios of 30-150. The addition of some hardware and devices such as additional piping, pumps, and membranes were helpful in the removal of THMs in a continuous water flow mode. The effects of pressure, air flow rate, and aeration time on THM removals were comparable to the batch-mode apparatus. See, FIGS. 6-8. The continuous-mode experiments were run with air-to-water ratios of 10-120.

The significance of running the pressurized aeration system in a continuous mode is that it represents what is observed in drinking water distribution systems, and would allow installment of pressurized, diffused aeration at any point in a water distribution system, where water would be stripped of volatile compounds, such as THMs, as it travels to its destination.

Although diffused aeration is established as a water treatment method, it is previously only been performed in systems at atmospheric pressure, and usually in large storage tanks that aerate one large volume (millions of gallons) of water at a time. (See reference to Applicant's own work, supra). Implementation of a diffused aeration system in a pressurized system (e.g. a pressurized aeration reactor) eliminates energy losses due to de-pressurization of the water upon entering a storage tank at atmospheric pressure. When water at high-pressure is reduced to atmospheric pressure for non-pressurized diffuse aeration, it must be re-pressurized after aeration in order to be sent to users. A pressurized diffused aeration system does not require de-pressurization to atmospheric pressure, but instead maintains system energy. This could lead to cost savings and improved system performance.

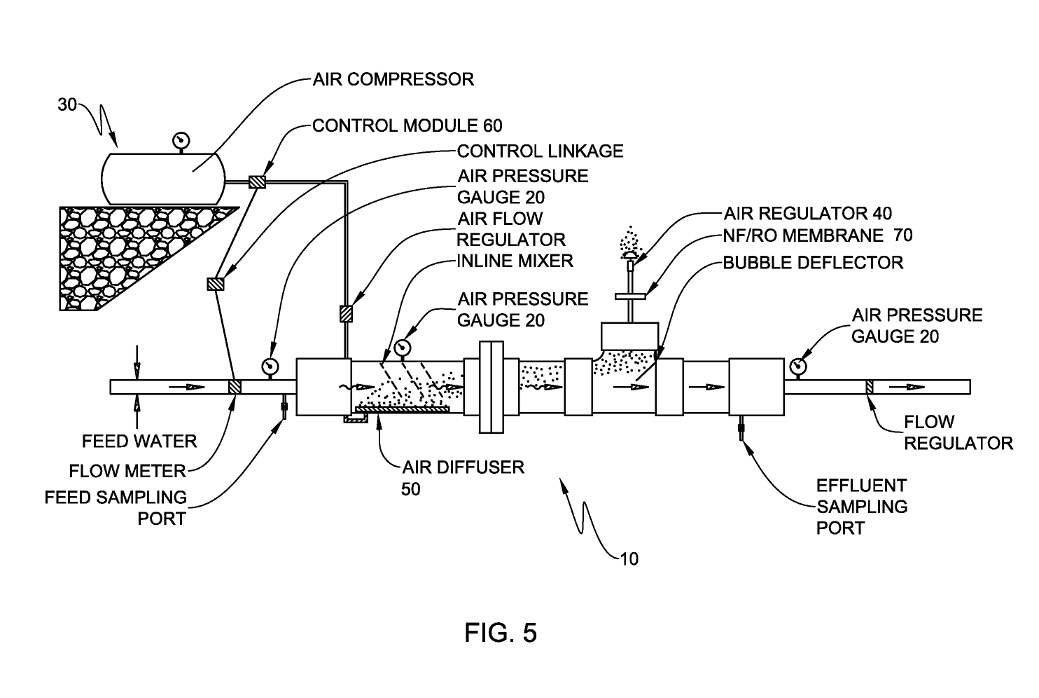

FIG. 5 is a schematic of another embodiment of the system and method of the present invention. This is an in-line, large-scale pressurized diffused aeration reactor comprising, a reactor 10, several pressure gauges 20, a source of influent air 30, which is controlled via a controller 60, the controller is monitoring the influent water flow which is monitored by a flow meter, and adjusting the influent air flow rate to maintain a predetermined air to water ratio, a diffuser 50 or network of diffusers, and a bubble deflector 70 to direct the VOC-containing air to the air release valve 40. The use of the controller allows for consistent air-to-water ratios, and the energy savings associated with only engaging the air source when water is flowing through the system.

Continuous, pressurized, diffused aeration is also useful in reducing VOCs pumped from groundwater remediation projects to the surface where the water can be treated without losing system pressure from the groundwater extraction pumps, thereby eliminating the need to pump the water again after stripping the VOCs by conventional means.

There are numerous VOCs that are found in groundwater, which are cause for environmental and/or public health concern. Some of the VOCs of interest might include alachlor, aldicarb, atrazine, benzene, carbofuran, carbon tetrachloride, chlorobenzene, cyanizine, dacthal, dicamba, 2,4D, dichlorobenzenes, dichloroethanes, dichloroethylenes, dichloromethane, ethylbenzene, mecoprop, methoxychlor, picloram, polychlorinated biphenyls, radon, simazine, tetrachloroethylene, toluene, trichloroethylene, vinyl chloride, xylenes, and the like.

A continuous, pressurized, diffused aeration system increases the flexibility of implementing aeration systems. Instead of treating large volumes of water at one time, a continuous aeration system could treat water as it travels through distribution pipes. This feature allows a continuous aeration system to be located anywhere within a distribution network, and even ideally at the exact problematic locations with peak contamination, instead of only in water treatment facilities. This is advantageous with respect to recent regulations requiring that compliance sampling for THMs occur at problematic, locations. THMs have been shown to increase with time in the distribution system, so problematic locations are likely to be in the far reaches of systems where storage tanks are not likely to be and/or are impractical to construct.

### EXPERIMENTAL

The following major components were present in a prototype apparatus: 3.0 L Reactor: 3.0 feet length of 3 inch ID clear PVC and 2 stainless steel end caps with rubber compression gaskets; an air diffuser (Aquatic Eco-Systems, Inc. Sweetwater Air Diffuser Model #ALS8); and a venting system (Swagelok RL3 Series). Other components that were used to operate the prototype apparatus include an air compressor and a peristaltic pump. All components of the apparatus were connected by ¼″ stainless steel pipe and ⅜″ flexible air hose, and operation involved the manipulation of multiple ball valves and the monitoring of a rotameter (air flow meter) and a pressure gauge. A schematic of the apparatus can be found in FIG. 3.

In order to test the percent removal of THMs using the pressurized diffused aeration system, stock solutions were made up for the following: 1 L MeOH; and 1 g/L TTHM (Total trihalomethanes), which consisted of about 40% CHCl₃, 20% CHBr₃, 20% CHBrCl₂, and 20% CHClBr, by weight. The challenge volume used was 4 L DI Water+1 mL stock solution for a final concentration of 250 μg/L TTHM.

In the batch-mode prototype apparatus, a volume of water was pumped into the device using a peristaltic pump. The reactor was pressurized by opening the ball valve at the top, allowing compressed air to flow into the reactor. At a pre-determined pressure (anywhere between 0 and 70 psig), the air release valve opened and began to let excess air in the reactor escape. This pressure was set by adjusting the air release valve.

Once air began to escape through the venting system, the ball valve at the top of the reactor was closed; cutting off the how of compressed air into the reactor. At that time, the reactor was at a constant elevated pressure between 0-70 psig. Then, pressurized aeration began by opening the ball valve connected to the diffuser, thus allowing air to flow through the diffuser. The diffuser separated the air flow into numerous tiny bubbles that travelled from the bottom of the reactor to the top of the reactor, and eventually out of the reactor through the air release valve. The air release valve allowed the system to maintain the same constant elevated pressure by allowing only excess air in the reactor to escape.

The apparatus continued to aerate the volume of water continuously until the air flow through the diffuser was stopped by closing the ball valve. The aerated water was then evacuated from the reactor for testing either through the sampling port at the bottom or by running the peristaltic pump in reverse. Alternatively, the samples were taken at any time during aeration through the sampling port. The pressurized diffuse aeration system demonstrated the removal of four major trihalomethanes (chloroform (“CF”), bromodichloromethane (“BDCM”), dibromochloromethane (“DCBM”), and bromoform (“BF”)).

In another example, a continuous-mode apparatus was constructed much like the apparatus above, with only minor adjustments. The prototype continuous-mode systems were operated as upright systems and horizontal systems. See FIGS. 2 and 4. The same procedures apply to the continuous-mode system as for the batch-mode system, except the water level was manually maintained by continually opening/closing a valve at the exit.

An inline system may include an actuated valve to automatically open/close the exit valve. The inline system may also include a controller that adjusts the air flow in relation to the influent water flow through a pressurized diffused aeration reactor. See FIG. 5. The controller would ensure a predetermined air-to-water ratio to achieve the target removals of VOCs. In addition, the use of a controller would allow the introduction of air only when water was flowing through the system, thus engaging the air compressor only when needed. Another example of minimizing the costs involved in implementing and running the system and method of the present invention.

The bench-scale, batch-mode diffused aeration system was run under system pressures of 0 psi, 25 psi, and 50 psi; air flow rates of 3 L/min, 6 L/min, and 9 L/min; and for 10 min, 20 min, and 30 min, which represent air-to-water ratios ranging from about 10 to about 120. All of the experiments were performed at 25° C. See Table 1, below. These levels were included in a full factorial experimental design, where all combinations of factors and levels were explored, resulting in 27 experiments. This allowed an ANOVA to assess the effects of each factor. See Tables 1 and 2, below.

ANOVA, analysis of variance, is a commonly used statistical method to assess if a factor is significant. In its simplest form ANOVA provides a statistical test of whether or not the means of several groups are all equal, and therefore generalizes the t-test to more than two groups. Doing multiple two-sample t-tests results in an increased chance of committing a type I error. For this reason, ANOVAs are useful in comparing two, three, or more means.

The 70 psi run was only performed at an air flow rate of 6 L/min and samples were obtained at 10 min, 20 min, and 30 min. The 70 psi data was not included in the ANOVA analysis, but was run to collect extra data at the most extreme pressures safely obtained with the bench-scale apparatus. See Table 3, below.

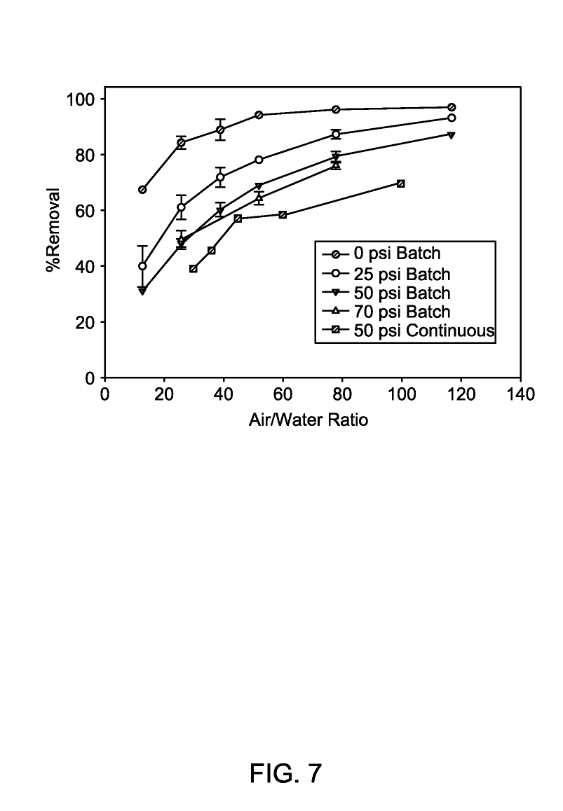

Results have shown that pressure has a significant effect on THM removals—increasing pressure reduces removals. See FIGS. 6 and 7. The ANOVA results in Table 2, below, quantify the effect of air flow rate, aeration time, and pressure on THM removals and allows comparison of effects. One of the most important design variables in aeration systems is the air-to-water ratio (air flow rate×time/water volume for batch systems; air flow rate/water flow rate for continuous systems). As the ANOVA in Table 2 shows, pressure is another important variable to consider in designing aeration systems.

The removal data for each pressure was compared, and the amount of THM removed by the system decreased with increasing system pressure.

TABLE I
Batch-mode, pressurized, diffused aeration studies with %
removals for individual THMs (data used in ANOVA analysis)

| | | Aeration | | | | | |
|---|---|---|---|---|---|---|---|
| Pressure | Air Flow | Time | % | % | % | % | % |
| (psig) | (L/min) | (min) | CF | BDCM | DBCM | BF | TTHM |
| 0 | 3 | 10 | 86 | 74 | 54 | 37 | 68 |
| 0 | 3 | 20 | 99 | 93 | 80 | 56 | 86 |
| 0 | 3 | 30 | 100 | 98 | 90 | 71 | 92 |
| 0 | 6 | 10 | 95 | 91 | 78 | 58 | 84 |
| 0 | 6 | 20 | 100 | 100 | 96 | 80 | 96 |
| 0 | 6 | 30 | 100 | 100 | 99 | 88 | 98 |
| 0 | 9 | 10 | 93 | 92 | 86 | 69 | 87 |
| 0 | 9 | 20 | 100 | 100 | 98 | 87 | 98 |
| 0 | 9 | 30 | 100 | 100 | 100 | 92 | 99 |
| 25 | 3 | 10 | 60 | 39 | 23 | 11 | 42 |
| 25 | 3 | 20 | 84 | 64 | 42 | 23 | 63 |
| 25 | 3 | 30 | 94 | 77 | 54 | 32 | 73 |
| 25 | 6 | 10 | 85 | 67 | 47 | 31 | 62 |
| 25 | 6 | 20 | 97 | 87 | 67 | 46 | 79 |
| 25 | 6 | 30 | 100 | 95 | 81 | 60 | 87 |
| 25 | 9 | 10 | 94 | 82 | 62 | 43 | 76 |
| 25 | 9 | 20 | 100 | 96 | 85 | 64 | 90 |
| 25 | 9 | 30 | 100 | 100 | 94 | 77 | 95 |
| 50 | 3 | 10 | 46 | 28 | 20 | 12 | 31 |
| 50 | 3 | 20 | 69 | 46 | 30 | 14 | 47 |
| 50 | 3 | 30 | 82 | 59 | 41 | 24 | 59 |
| 50 | 6 | 10 | 71 | 50 | 35 | 22 | 50 |
| 50 | 6 | 20 | 91 | 75 | 55 | 37 | 70 |
| 50 | 6 | 30 | 97 | 87 | 68 | 46 | 79 |
| 50 | 9 | 10 | 84 | 65 | 48 | 32 | 63 |
| 50 | 9 | 20 | 98 | 88 | 71 | 50 | 82 |
| 50 | 9 | 30 | 100 | 95 | 82 | 61 | 88 |

Referring to Table 2, as one reads down the table of ANOVA data from the batch-mode runs, there is an increasing effect of pressure and air flow rate; and a decreasing effect of aeration time for the various THMs. The maximum contribution of error was 11.3%. Based on preliminary studies, the continuous-mode, pressurized, diffused aeration system shows similar trends. See FIGS. 6-8 and Table 4.

TABLE 2

| | Contribution to Removal |
|---|---|
| CHCl₃ | |
| Pressure | 19.3% |
| Air Flow Rate | 23.8% |
| Aeration Time | 27.4% |
| CHCl₂Br | |
| Pressure | 31.6% |
| Air Flow Rate | 28.0% |
| Aeration Time | 24.4% |
| CHClBr₂ | |
| Pressure | 38.4% |
| Air Flow Rate | 30.1% |
| Aeration Time | 22.8% |
| CHBr₃ | |
| Pressure | 41.5% |
| Air Flow Rate | 31.2% |
| Aeration Time | 19.9% |

TABLE 3
Batch-mode, pressurized, diffused aeration studies
with % removals for individual THMs and TTHMs

| | | Aeration | | | | | |
|---|---|---|---|---|---|---|---|
| Pressure | Air Flow | Time | % | % | % | % | % |
| (psig) | (L/min) | (min) | CF | BDCM | DBCM | BF | TTHM |
| 70 | 6 | 10 | 77 | 54 | 27 | 28 | 52 |
| 70 | 6 | 10 | 66 | 47 | 32 | 22 | 48 |
| 70 | 6 | 20 | 87 | 70 | 46 | 29 | 63 |
| 70 | 6 | 20 | 87 | 68 | 48 | 35 | 67 |
| 70 | 6 | 30 | 95 | 83 | 62 | 47 | 76 |
| 70 | 6 | 30 | 95 | 81 | 62 | 46 | 77 |

TABLE 4
Continuous-mode, pressurized, diffused aeration studies
with % removals for individual THMs and TTHMs

| Pressure | Air Flow | Water Flow | % | % | % | % | % |
|---|---|---|---|---|---|---|---|
| (psig) | (L/min) | (mL/min) | CF | BDCM | DBCM | BF | TTHM |
| 50 | 9 | 90 | 85 | 75 | 60 | 44 | 69 |
| 50 | 9 | 150 | 77 | 64 | 48 | 32 | 59 |
| 50 | 9 | 200 | 77 | 62 | 46 | 33 | 59 |
| 50 | 9 | 250 | 68 | 52 | 34 | 23 | 49 |
| 50 | 9 | 300 | 63 | 43 | 28 | 19 | 43 |

Calculation of Henry's Law Constants:

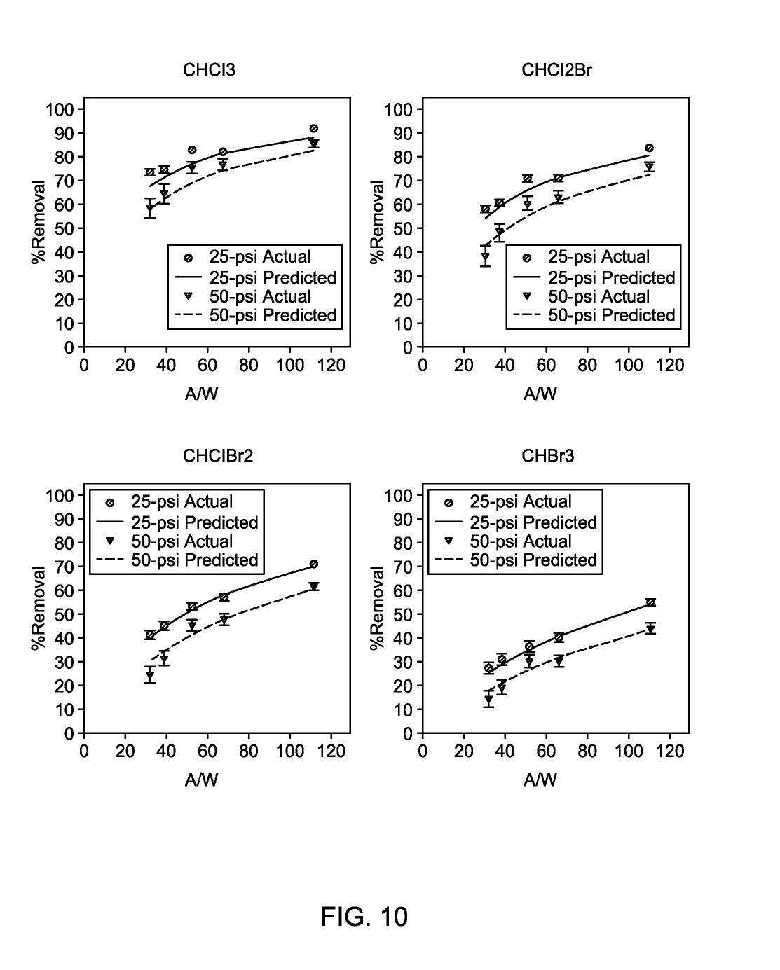

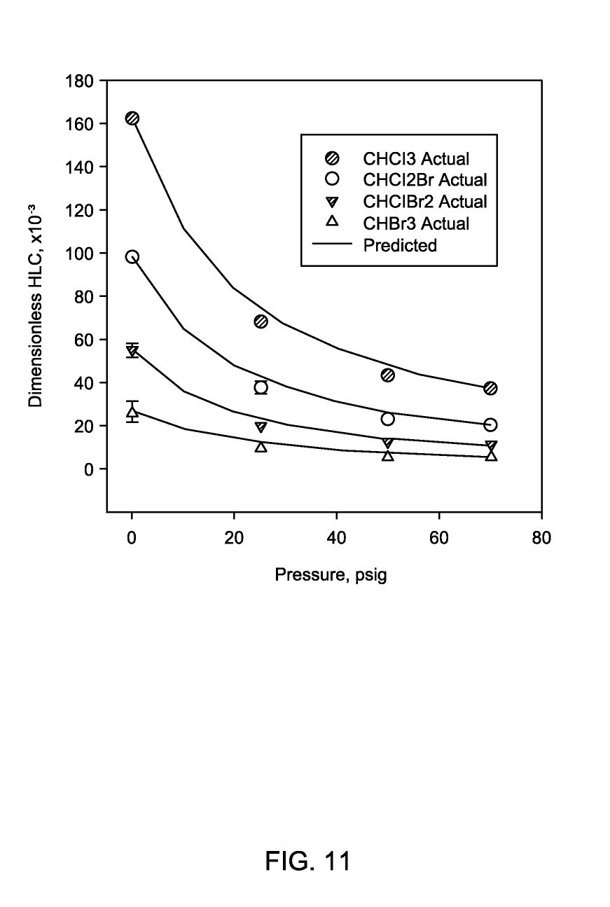

Henry's Law constants at varied pressures were first calculated using a direct approach discussed in Mackay et al., Determination of Air-Water Henry's Law Constants for Hydrophobic Pollutants, Env. Sci. Tech., 13(3), pp. 333-337 (1979). Calculations were made for each trihalomethane, pressure, and airflow rate. The resulting experimental Henry's Law constants are found in Table 5. Experimentally determined Henry's Law constants (HLCs) at atmospheric pressure were compared to literature atmospheric Henry's Law constants in order to check the quality of the results. Staudinger, et al., A critical review of Henry's Law constants for environmental applications, Critical Rev. Env. Sci. & Tech., 26(3), pp. 205-297 (1996). See FIGS. 10 and 11. This comparison is also displayed in Table 6.

TABLE 5
Experimental Henry's Law constants at 25° C., ×10⁻³ (Dimensionless)

| | 0-psi | 25-psi | 50-psi | 70-psi |
|---|---|---|---|---|
| CHCl₃ | 163 | 69.9 ± 0.849 | 45.6 ± 1.30 | 39.3 |
| CHCl₂Br | 100 | 39.5 ± 2.75 | 25.2 ± 1.62 | 22.5 |
| CHClBr₂ | 57.0 ± 2.79 | 21.9 ± 1.66 | 14.6 ± 0.833 | 12.4 |
| CHBr₃ | 28.0 ± 4.34 | 11.6 ± 1.26 | 7.86 ± 0.899 | 8.01 |

TABLE 6
Atmospheric Henry's Law constants at 25° C., ×10⁻³ (Dimensionless)

| | Literature | Experiments |
|---|---|---|
| CHCl₃ | 162 ± 15 | 163 |
| CHCl₂Br | 101 ± 33 | 100 |
| CHClBr₂ | 47.2 ± 2.5 | 57.0 ± 2.79 |
| CHBr₃ | 23.1 ± 1.4 | 28.0 ± 4.34 |

Relationship Between Henry's Law Constant and System Pressure:

In order to determine the relationship between Henry's Law constant (H) and system pressure (P), it is first necessary to determine the order of the relationship. An approach similar to determining the order of a chemical reaction was utilized. First, trends of system pressure with In(H/H₀) [first-order] and H⁻¹ [second-order] were observed; where H₀ is Henry's Law constant at atmospheric pressure. The trend of system pressure with H⁻¹ is most closely linear, therefore it was determined that the relationship between Henry's Law constant and system pressure is approximately a second-order expression. An expression relating Henry's Law constant to system pressure can then be formulated,

$$\frac{1}{H} - \frac{1}{{H}_{0}} = kP \qquad ( Eq . 1 )$$

where H is Henry's Law constant at system pressure, P; H₀ is Henry's Law constant at atmospheric pressure; and k is a rate constant (calculated as the slope of the linear regression in the pressure vs. H⁻¹ plot). Calculated rate constants for each trihalomethane can be found in Table 7.

TABLE 7
Second-Order Rate Constants k, psig⁻¹

| | |
|---|---|
| CHCl₃ | 0.281 |
| CHCl₂Br | 0.505 |
| CHClBr₂ | 0.906 |
| CHBr₃ | 1.34 |

Predicting Henry's Law Constant for Given System Pressure:

With an atmospheric Henry's Law constant (H₀) and a second-order rate constant (k), Eq. 1 can then be used to calculate Henry's Law constants at various pressures for each trihalomethane. FIG. 11 displays the experimentally determined Henry's Law constants from Table 3, along with predicted Henry's Law constants calculated using Eq. 1. The predicted values in FIG. 11 were obtained from a model calibrated with the current experimental results; therefore this is not a validation of the current model but rather a demonstration of the ability of the current model to predict the results with which it was calibrated.

An example calculation for chloroform at 50 psi is shown below. Data was collected at air flow rates of 3 L/min, 6 L/min, and 9 L/min at various chloroform concentrations and various contact times. The HLC of 0.0456 was the average of all three air flow rates tested with a standard deviation of 0.0013. The calculations for the other THMs used the same method.

3-L/min

| Time | | |
|---|---|---|
| min | Concentration ppb | -ln(C/C0) |
| 0 | 110 | 0 |
| 10 | 59 | 0.623 |
| 20 | 34 | 1.17 |
| 30 | 20 | 1.70 |

$H = \frac{slope \times V}{G} = \frac{0.0578 {min}^{- t} \times 2.3 - L}{3 - LPM} = 0.0443$

6-L/min

| Time | | |
|---|---|---|
| min | Concentration ppb | -ln(C/C0) |
| 0 | 110 | 0 |
| 10 | 33 | 1.20 |
| 20 | 9.9 | 2.41 |
| 30 | 3.1 | 3.57 |

$H = \frac{slope \times V}{G} = \frac{0.1195 {min}^{- t} \times 2.3 - L}{6 - LPM} = 0.0458$

9-L/min

| Time | | |
|---|---|---|
| min | Concentration ppb | -ln(C/C0) |
| 0 | 100 | 0 |
| 10 | 17 | 1.77 |
| 20 | 2.5 | 3.69 |

$H = \frac{slope \times V}{G} = \frac{0.18 \; 30 {min}^{- t} \times 2.3 - L}{9 - LPM} = 0.0468$

Referring to FIGS. 6 and 7, the dimensionless volumetric air to water (A/W) ratio was calculated, using the equation below, for each of the experimental runs in Tables 1 and 4. Sec Table 8, below.

$$A / {W}_{Batch} = \frac{{Q}_{AIR} \times CT}{{V}_{WATER}}$$

The following equations represent the trends demonstrated by the studies.

$$H = \frac{THM Concentration in Gas}{Bulk Liquid THM Concentration} \\ ↑ System Pressure ⇒ \frac{↓ Gaseous Concentration}{↑ Bulk Liquid Concentration} ⇒ ↓ H$$

$$THM Removal = 1 - exp ( - H \times A / W ) \\ ∴ ↓ H ⇒ ↓ THM Removals$$

TABLE 8
Air-to-water ratios for some pressurized, diffused aeration studies

| | | | | |
|---|---|---|---|---|
| Air | | | | |
| Flow Rate | Aeration Time | Water Volume | Water Flow Rate | A/W |
| (L/min) | (min) | (L) | (L/min) | ratio |

Batch-mode

| | | | | |
|---|---|---|---|---|
| 3 | 10 | 2.3 | N/A | 13 |
| 3 | 20 | 2.3 | N/A | 26 |
| 3 | 30 | 2.3 | N/A | 39 |
| 6 | 10 | 2.3 | N/A | 26 |
| 6 | 20 | 2.3 | N/A | 52 |
| 6 | 30 | 2.3 | N/A | 78 |
| 9 | 10 | 2.3 | N/A | 39 |
| 9 | 20 | 2.3 | N/A | 78 |
| 9 | 30 | 2.3 | N/A | 117 |

Continuous-mode

| | | | | |
|---|---|---|---|---|
| 9 | N/A | N/A | 0.09 | 100 |
| 9 | N/A | N/A | 0.15 | 60 |
| 9 | N/A | N/A | 0.20 | 45 |
| 9 | N/A | N/A | 0.25 | 36 |
| 9 | N/A | N/A | 0.30 | 30 |

Several continuous-mode runs were conducted as follows. Challenge volumes were mixed by filling 20 L plastic carboys with 15 L DI water each, then adding 4.5 mL of TTHM stock solution (1.0 g/L) to each carboy, and mixing for 30 minutes on a magnetic stir plate. The target concentration was 300 ppb TTHM (120 ppb CHCl₃ and 60 ppb each of CHCl₂Br, CHClBr₂, and CHBr₃).

The reactor was filled with a challenge volume using a peristaltic pump. The air valve was opened and adjusted to the desired air flow rate. The proportional air relief valve was adjusted to the desired pressure. The peristaltic pump was set to the desired water flow rate and let run for 1.5 hydraulic residence times (reactor volume divided by water flow rate) before taking samples. The initial concentration sample was taken out of the appropriate sampling port when desired. The following are exemplary procedures and sampling times for 9 L/min air, 50 psi runs:

Fill reactor with challenge volume.

Open air valve and adjust to 9 L/min and 50 psi.

Set pump to 300 mL/min water and let run for 12.5 minutes (2.5 L/300 mL/min×1.5).

Take initial concentration and effluent samples.

Reduce water flow to 250 mL/min and let run for 15 minutes.

Take effluent sample.

Reduce water flow to 200 mL/min and let run for 18.75 minutes.

Take initial concentration and effluent samples.

Reduce water flow to 150 mL/min and let run for 25 minutes.

Take effluent sample.

Reduce water flow to 90 mL/min and let run for 42 minutes.

Take initial concentration and effluent samples.

All samples were taken directly from influent and effluent sampling ports in a 125 mL Erlenmeyer flask. The dissolved air was allowed to equilibrate with the atmosphere to prevent bubble formation in the sample vials, and the samples were transferred to final 40 mL sample vials using 50 mL glass pipettes and an autopipettor. The temperatures of the challenge volumes were 24° C. before pumping and 22° C. after aeration.

Five runs each of pressurized continuous-flow aeration were performed at 25 psi and 50 psi with THM-spiked challenge volumes. Some variation in trihalomethane initial concentrations was observed throughout the 25 psi and 50 psi continuous-flow experiments. A summary of this variation is displayed in Table 9 and Table 10. Percent removals were calculated with each initial concentration, and an average and standard deviation were calculated from these values.

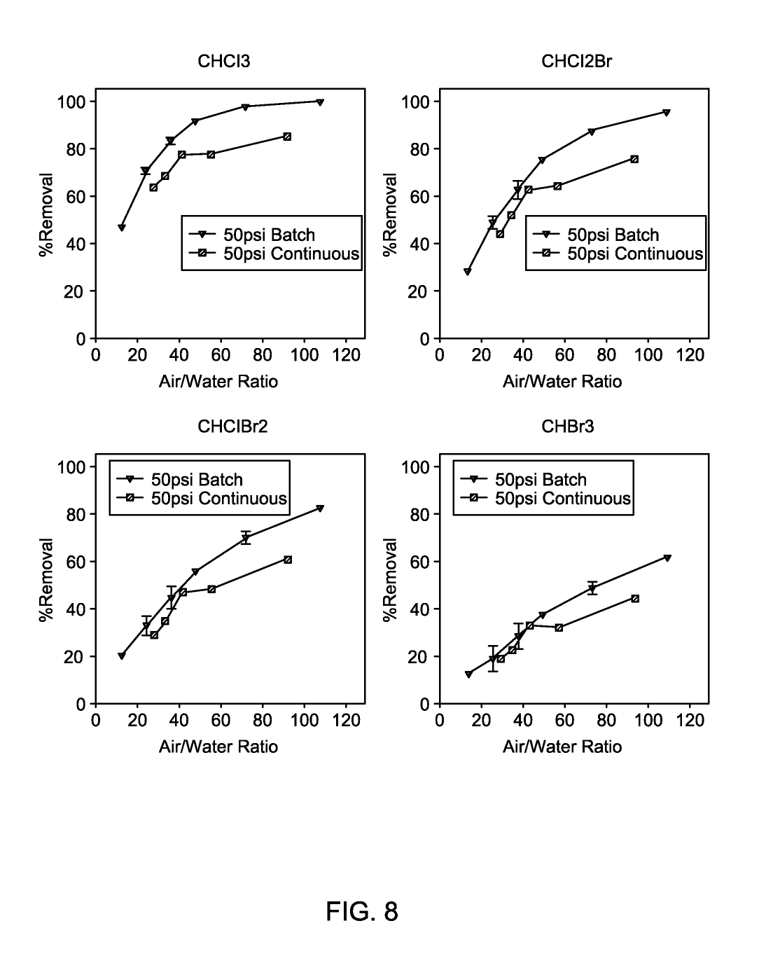

Percent removals achieved at various air/water ratios (e.g. air volume divided by water volume) for both the continuous-flow and batch-mode systems are displayed in FIG. 8. From the results of FIG. 8, it is clear that there is a difference in removals at the same pressure and air/water ratio between the batch and continuous flow systems. Therefore, the same predictive model cannot be utilized for both.

TABLE 9
Initial Concentration Measurements - 25 psi Continuous-mode (in ppb)

| Cumulative | | | | |
|---|---|---|---|---|
| Time, min | CHCl₃ | CHCl₂Br | CHClBr₂ | CHBr₃ |
| 21 | 95 | 48 | 50 | 53 |
| 60 | 102 | 51 | 53 | 57 |
| 131 | 92 | 47 | 50 | 54 |
| Average | 96 | 49 | 51 | 55 |
| St. Dev. | 5.13 | 2.08 | 1.73 | 2.08 |

TABLE 10
Initial Concentration Measurements - 50 psi Continuous-mode (in ppb)

| Cumulative | | | | |
|---|---|---|---|---|
| Time, min | CHCl₃ | CHCl₂Br | CHClBr₂ | CHBr₃ |
| 20.8 | 92 | 44 | 46 | 45 |
| 54.8 | 83 | 41 | 44 | 45 |
| 121.8 | 75 | 38 | 42 | 42 |
| Average | 83 | 41 | 44 | 44 |
| St. Dev. | 8.50 | 3.00 | 2.00 | 1.73 |

A THM-spiked challenge volume was pumped into the pressurized continuous-flow aeration apparatus and VOC removals were observed by taking an initial concentration at the beginning and an effluent concentration after one and a half hydraulic residence times (water volume divided by water flow rate). The resulting factor levels for the pressurized continuous-flow aeration experiments are displayed in Table

TABLE 11
Design for pressurized, continuous-flow, diffused aeration experiments

| Water Flow rate | Air Flow rate | Pressure | Resulting A/W Ratio |
|---|---|---|---|
| 90 mL/min | 9 L/min | 25 psig | 100 |
| 150 mL/min | | 50 psig | 60 |
| 200 mL/min | | | 45 |
| 250 mL/min | | | 36 |
| 300 mL/min | | | 30 |

The same general setup of the pressurized batch aeration apparatus was used for the pressurized continuous flow aeration apparatus, except with minor adjustments. The adjustments made to the pressurized batch aeration apparatus to make water flow continuously include: adding a ¼″ inlet pipe for water at the top of the apparatus that extends to slightly below the water surface, and connecting the peristaltic pump to this inlet pipe; adding an initial concentration sampling port just before the spiked water enters the apparatus; removing the internal sampling port within the apparatus; and adding a water effluent pipe at the bottom of the apparatus, fitted with a gate valve for adjusting water effluent flow rate.

Continuous-Mode VOC Removal Predictive Model:

Matter-Müller et. al. (1981) suggest a mathematical model to predict VOC removals in a continuous-flow system once the air bubbles were determined to be at saturation:

$$\% Removal = ( 1 - \frac{1}{1 + \frac{{Q}_{G} {H}_{cc}}{{Q}_{L}}} ) \times 100. \qquad ( x )$$

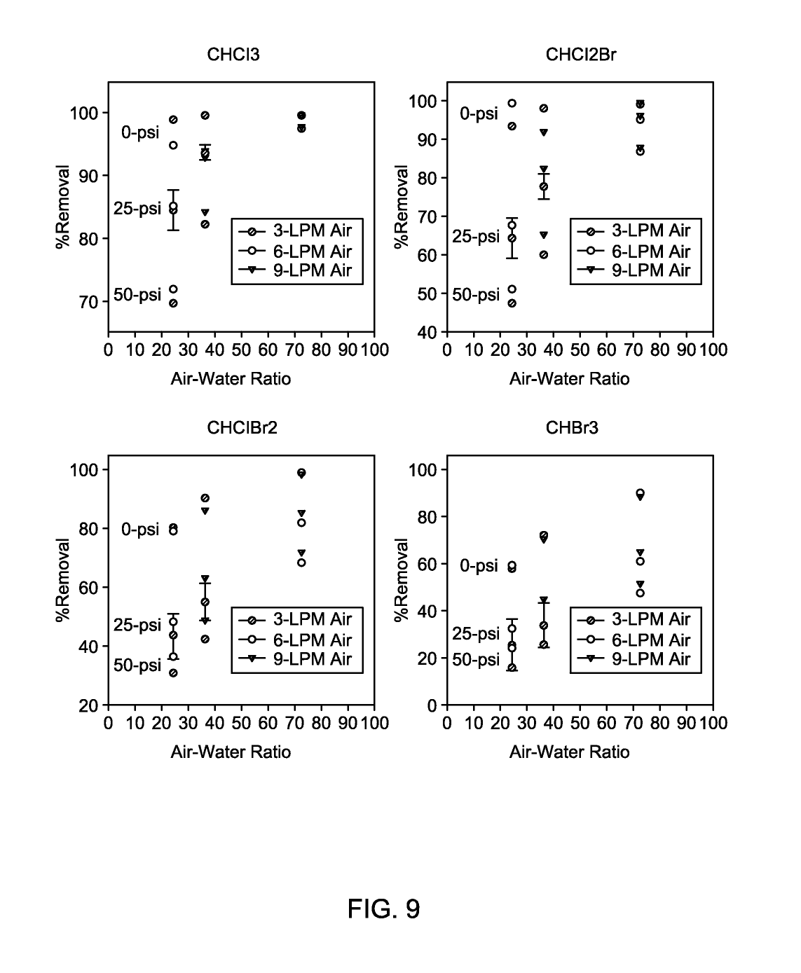

The inherent assumption in using Mackay's batch aeration method to calculate Henry's Law Constant is that equilibrium exists at the air-water interface (i.e. the bubbles are saturated before they detach from the water), thus allowing the application of Henry's Law. This assumption is validated in the experiments of this report by observing the similarities in removals between different air flow rates in FIG. 9. For example, the same removal of chloroform was observed by aerating at 3-L/min for 30 minutes and at 9-L/min for 10 minutes. In each case, the same total volume of air was passed through the liquid. For the same removal to occur, these volumes of air that came in contact with the liquid must have taken up the same amount of chloroform. If the maximum amount of chloroform was not taken up by either of the flow rate conditions, one would expect the 9-L/min airflow conditions to produce a lesser uptake of chloroform since the same volume of air is sent through the water at a much faster rate (i.e. less contact time). But, a similar removal was observed, and since similar initial concentrations existed throughout all experiments, this suggests that the volume of air at both flow rates took up the most chloroform possible; or in other words, equilibrium conditions exist for both the 3-L/min and 9-L/min flow rate conditions and Henry's Law is applicable.

The predicted removals can be compared to the continuous-flow trihalomethane removal data in FIG. 8 by inserting the appropriate air flow rate, water flow rate, and Henry's Law Constant. The actual versus predicted comparison for 25 psi and 50 psi with 9 L/min air continuous flow aeration experiments is displayed in FIG. 10. As demonstrated, a strong agreement was observed between the predictive model and the measured results for both pressures.

Depending on the disinfection system used, and the species of THMs present in the water distribution system, the percent removal of THMs and TTHMs may vary. For example, chloroform has been shown to be reduced by about 99%, while bromoform is generally only reduced by about 40%.

In one embodiment, the percent reduction in volatile organic compounds is from about 1% to about 99%. In one embodiment, the percent reduction in volatile organic compounds is from about 5% to about 95%. In one embodiment, the percent reduction in volatile organic compounds is from about 10% to about 90%. In one embodiment, the percent reduction in volatile organic compounds is from about 15% to about 85%. In one embodiment, the percent reduction in volatile organic compounds is from about 20% to about 80%. In one embodiment, the percent reduction in volatile organic compounds is from about 25% to about 75%. In one embodiment, the percent reduction in volatile organic compounds is from about 30% to about 70%. In one embodiment, the percent reduction in volatile organic compounds is from about 35% to about 65%. In one embodiment, the percent reduction in volatile organic compounds is from about 40% to about 60%. In one embodiment, the percent reduction in volatile organic compounds is from about 45% to about 55%. In one embodiment, the percent reduction in volatile organic compounds is about 1%, about 2%, about 3%, about 4%, about 5%, about 6%, about 7%, about 8%, about 9%, or about 10%. In one embodiment, the percent reduction in volatile organic compounds is about 11%, about 12%, about 13%, about 14%, about 15%, about 16%, about 17%, about 18%, about 19%, or about 20%. In one embodiment, the percent reduction in volatile organic compounds is about 21%, about 22%, about 23%, about 24%, about 25%, about 26%, about 27%, about 28%, about or about 30%. In one embodiment, the percent reduction in volatile organic compounds is about 31%, about 32%, about 33%, about 34%, about 35%, about 36%, about 37%, about 38%, about 39%, or about 40%. In one embodiment, the percent reduction in volatile organic compounds is about 41%, about 42%, about 43%, about 44%, about 45%, about 46%, about 47%, about 48%, about 49%, or about 50%. In one embodiment, the percent reduction in volatile organic compounds is about 51%, about 52%, about 53%, about 54%, about 55%, about 56%, about 57%, about 58%, about 59%, or about 60%. In one embodiment, the percent reduction in volatile organic compounds is about 61%, about 62%, about 63%, about 64%, about 65%, about 66%, about 67%, about 68%, about 69%, or about 70%. In one embodiment, the percent reduction in volatile organic compounds is about 71%, about 72%, about 73%, about 74%, about 75%, about 76%, about 77%, about 78%, about 79%, or about 80%. In one embodiment, the percent reduction in volatile organic compounds is about 81%, about 82%, about 83%, about 84%, about 85%, about 86%, about 87%, about 88%, about 89%, or about 90%. In one embodiment, the percent reduction in volatile organic compounds is about 91 about 92%, about 93%, about 94%, about 95%, about 96%, about 97%, about 98%, or about 99%.

In one embodiment, the percent reduction in total trihalomethanes is from about 1 to about 99%. In one embodiment, the percent reduction in total trihalomethanes is from about 5% to about 95%. In one embodiment, the percent reduction in total trihalomethanes is from about 10% to about 90%. In one embodiment, the percent reduction in total trihalomethanes is from about 15% to about 85%. In one embodiment, the percent reduction in total trihalomethanes is from about 20% to about 80%. In one embodiment, the percent reduction in total trihalomethanes is from about 25% to about 75%. In one embodiment, the percent reduction in total trihalomethanes is from about 30 to about 70%. In one embodiment, the percent reduction in total trihalomethanes is from about 35% to about 65%. In one embodiment, the percent reduction in total trihalomethanes is from about 40% to about 60%. In one embodiment, the percent reduction in total trihalomethanes is from about 45% to about 55%. In one embodiment, the percent reduction in total trihalomethanes is about 1%, about 2%, about 3%, about 4%, about 5%, about 6%, about 7%, about 8%, about 9%, or about 10%. In one embodiment, the percent reduction in total trihalomethanes is about 11%, about 12%, about 13%, about 14%, about 15%, about 16%, about 17%, about 18%, about 19%, or about 20%. In one embodiment, the percent reduction in total trihalomethanes is about 21%, about 22%, about 23%, about 24%, about 25%, about 26%, about 27%, about 28%, about 29%, or about 30%. In one embodiment, the percent reduction in total trihalomethanes is about 31%, about 32%, about 33%, about 34%, about 35%, about 36%, about 37%, about 38%, about 39%, or about 40%. In one embodiment, the percent reduction in total trihalomethanes is about 41%, about 42%, about 43%, about 44%, about 45%, about 46%, about 47%, about 48%, about 49%, or about 50%. In one embodiment, the percent reduction in total trihalomethanes is about 51%, about 52%, about 53%, about 54%, about 55%, about 56%, about 57%, about 58%, about 59%, or about 60%. In one embodiment, the percent reduction in total trihalomethanes is about 61%, about 62%, about 63%, about 64%, about 65%, about 66%, about 67%, about 68%, about 69%, or about 70%. In one embodiment, the percent reduction in total trihalomethanes is about 71%, about 72%, about 73%, about 74%, about 75%, about 76%, about 77%, about 78%, about 79%, or about 80%. In one embodiment, the percent reduction in total trihalomethanes is about 81%, about 82%, about 83%, about 84%, about 85%, about 86%, about 87%, about 88%, about 89%, or about 90%. In one embodiment, the percent reduction in total trihalomethanes is about 91%, about 92%, about 93%, about 94%, about 95%, about 96%, about 97%, about 98%, or about 99%.

In one embodiment, the pressure will range from 0 psi to about 120 psi. In one embodiment, the pressure of the system will range from 10 psi to about 110 psi. In one embodiment, the pressure of the system will range from 20 psi to about 100 psi. In one embodiment, the pressure of the system will range from 30 psi to about 90 psi. In one embodiment, the pressure of the system will range from 40 psi to about 80 psi. In one embodiment, the pressure of the system will range from 50 psi to about 70 psi. In one embodiment, the pressure of the system is about 5 psi, about 10 psi, about 15 psi, about 20 psi, about 25 psi, about 30 psi, about 35 psi, about 40 psi, about 45 psi, or about 50 psi. In one embodiment, the pressure of the system is about 55 psi, about 60 psi, about 65 psi, about 70 psi, about 75 psi, about 80 psi, about 85 psi, about 90 psi, about 95 psi, or about 100 psi. In one embodiment, the pressure of the system is about 105 psi, about 110 psi, about 115 psi, or about 120 psi.

In one embodiment, the water flow rate is from about 0.1 L/min to about 20 L/min. In one embodiment, the water flow rate is from about 0.2 L/min to about 19 L/min. In one embodiment, the water flow rate is from about 0.3 L/min to about 18 L/min. In one embodiment, the water flow rate is from about 0.4 L/min to about 17 L/min. in one embodiment, the water flow rate is from about 0.5 L/min to about 16 L/min. In one embodiment, the water flow rate is from about 0.6 L/min to about 15 L/min. In one embodiment, the water flow rate is from about 0.7 L/min to about 14 L/min. In one embodiment, the water flow rate is from about 0.8 L/min to about 13 L/min. In one embodiment, the water flow rate is from about 0.9 L/min to about 12 L/min. In one embodiment, the water flow rate is from about 1 L/min to about 11 L/min. In one embodiment, the water flow rate is form about 2 L/min to about 10 L/min. In one embodiment, the water flow rate is from about 3 L/min to about 9 L/min. In one embodiment, the water flow rate is from about 4 L/min to about 8 L/min. In one embodiment, the water flow rate is from about 5 L/min. to about 7 L/min. In one embodiment, the water flow rate is about 0.1 L/min, about 0.2 L/min, about 0.3 L/min, about 0.4 L/min, about 0.5 L/min, about 0.6 L/min, about 0.7 L/min, about 0.8 L/min, or about 0.9 L/min. In one embodiment, the water flow rate is about 1 L/min, about 2 L/min, about 3 L/min, about 4 L/min, about 5 L/min, about 6 L/min, about 7 L/min, about 8 L/min, about 9 L/min or about 10 L/min. In one embodiment, the water flow rate is about 11 L/min, about 12 L/min, about 13 L/min, about 14 L/min, about 15 L/min, about 16 L/min, about 17 L/min, about 18 L/min, about 19 L/min, or about 20 L/min.

In one embodiment, the air-to-water ratio is from about 1 to about 150. In one embodiment, the air-to-water ratio is from about 5 to about 145. In one embodiment, the air to water ratio is from about 10 to about 140. In one embodiment, the air-to-water ratio is from about 15 to about 135. In one embodiment, the air-to-water ratio is from about 20 to about 130. In one embodiment, the air-to-water ratio is from about 25 to about 125. In one embodiment, the air-to-water ratio is from about 30 to about 120. In one embodiment, the air-to-water ratio is from about 35 to about 115. In one embodiment, the air-to-water ratio is from about 40 to about 110. In one embodiment, the air-to-water ratio is from about 45 to about 105. In one embodiment, the air-to-water ratio is from about 50 to about 100. In one embodiment, the air-to-water ratio is from about 55 to about 95. In one embodiment, the air to water ratio is from about 60 to about 90. In one embodiment, the air-to-water ratio is from about 65 to about 85. In one embodiment, the air-to-water ratio is from about 70 to about 80. In one embodiment, the air-to-water ratio is about 1, about 2, about 3, about 4, about 5, about 6, about 7, about 8, about 9, about 10, about 11, about 12, about 13, about 14, or about 15. In one embodiment, the air-to-water ratio is about 16, about 17, about 18, about 19, about 20, about 21, about 22, about 23, about 24, about 25, or about 26. In one embodiment, the air-to-water ratio is about 27, about 28, about 29, about 30, about 31, about 32, about 33, about 34, about 35, about 36, or about 37. In one embodiment, the air-to-water ratio is about 38, about 39, about 40, about 41, about 42, about 43, about 44, about 45, about 46, about 47, or about 48. In one embodiment, the air-to-water ratio is about 49, about 50, about 51, about 52, about 53, about 54, about 55, about 56, about 57, about 58, or about 59. In one embodiment, the air-to-water ratio is about 60, about 61, about 62, about 63, about 64, about 65, about 66, about 67, about 68, about 69, or about 70. In one embodiment, the air-to-water ratio is about 71, about 72, about 73, about 74, about 75, about 76, about 77, about 78, about 79, about 80, or about 81. In one embodiment, the air-to-water ratio is about 82, about 83, about 84, about 85, about 86, about 87, about 88, about 89, about 90, about 91, or about 92. In one embodiment, the air-to-water ratio is about 93, about 94, about 95, about 96, about 97, about 98, about 99, about 100, about 101, about 102, or about 103. In one embodiment, the air-to-water ratio is about 104, about 105, about 106, about 107, about 108, about 109, about 110, about 111, about 112, about 113, or about 114. In one embodiment, the air-to-water ratio is about 115, about 116, about 117, about 118, about 119, about 120, about 121, about 122, about 123, about 124, or about 125. In one embodiment, the air-to-water ratio is about 126, about 127, about 128, about 129, about 130, about 131, about 132, about 133, about 134, about 135, or about 136. In one embodiment, the air-to-water ratio is about 137, about 138, about 139, about 140, about 141, about 142, about 143, about 144, about 145, about 146, about 147, about 148, about 149, or about 150.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. A system for reducing the concentration of volatile organic compounds in water comprising,
a pressurized reactor containing influent water with a first concentration of volatile organic compounds;
a mechanism for introducing air into the reactor at a flow rate proportional to the influent water flow rate represented by an air-to-water ratio, thereby causing the air to flow through the influent water; and
a venting system configured to release air containing volatile organic compounds from the reactor causing the air, after flowing through the influent water with a first concentration of volatile organic compounds, to escape the reactor thereby reducing the concentration of volatile organic compounds in the effluent water to a second concentration.

2. The system for reducing the concentration of volatile organic compounds in water of claim 1, wherein the reactor is a pressurized aeration reactor.

3. The system for reducing the concentration of volatile organic compounds in water of claim 1, wherein the reactor is a modified pipe in a water distribution system.

4. The system for reducing the concentration of volatile organic compounds in water of claim 1, wherein the volatile organic compound is a trihalomethane.

5. The system for reducing the concentration of volatile organic compounds in water of claim 1, wherein the mechanism for introducing air into the reactor comprises an air compressor.

6. The system for reducing the concentration of volatile organic compounds in water of claim 1, wherein mechanism for introducing air into the reactor further comprises breaking the air flow into bubbles.

7. The system for reducing the concentration of volatile organic compounds in water of claim 6, wherein the mechanism for introducing air into the reactor comprises a diffuser.

8. The system for reducing the concentration of volatile organic compounds in water of claim 1, wherein the mechanism for introducing air into the reactor comprises a controller.

9. The system for reducing the concentration of volatile organic compounds in water of claim 1, wherein the venting system comprises an air release valve.

10. The system for reducing the concentration of volatile organic compounds in water of claim 1, wherein the venting system comprises a membrane.

11. The system for reducing the concentration of volatile organic compounds in water of claim 1, wherein the pressure in the reactor is from about 20 psi to about 120 psi.

12. The system for reducing the concentration of volatile organic compounds in water of claim 1, wherein the air-to-water ratio is from about 1 to about 150.

13. The system for reducing concentration of volatile organic compounds in water of claim 1, wherein the concentration of volatile organic compounds in the water is reduced by about 1% to about 99%.

14. A method of reducing the concentration of volatile organic compounds in water comprising,
introducing water with a first concentration of volatile organic compounds into a pressurized reactor;
introducing air into the reactor at a flow rate proportional to the influent water flow rate represented by an air-to-water ratio, thereby causing the air to flow through the influent water; and
releasing air from the pressurized reactor through a venting system configured to release air containing volatile organic compounds from the reactor causing the air, after flowing through the influent water with a first concentration of volatile organic compounds, to escape the reactor thereby reducing the concentration of volatile organic compounds in the effluent water to a second concentration.

15. The method of reducing the concentration of volatile organic compounds in water of claim 14, wherein the reactor is a pressurized aeration reactor.

16. The method of reducing the concentration of volatile organic compounds in water of claim 14, wherein the reactor is a modified pipe in a water distribution system.

17. The method of reducing the concentration of volatile organic compounds in water of claim 14, wherein the volatile organic compound is a trihalomethane.

18. The method of reducing the concentration of volatile organic compounds in water of claim 14, wherein the step of introducing air into the reactor comprises an air compressor.

19. The method of reducing the concentration of volatile organic compounds in water of claim 14, wherein step of introducing air into the reactor further comprises breaking the air flow into bubbles.

20. The method of reducing the concentration of volatile organic compounds in water of claim 19, wherein the step of introducing air into the reactor comprises a diffuser.

21. The method of reducing the concentration of volatile organic compounds in water of claim 14, wherein the step of introducing air into the reactor comprises a controller.

22. The method of reducing the concentration of volatile organic compounds in water of claim 14, wherein the venting system comprises an air release valve.

23. The method of reducing the concentration of volatile organic compounds in water of claim 14, wherein the venting system comprises a membrane.

24. The method of reducing the concentration of volatile organic compounds in water of claim 14, wherein the pressure in the reactor is from about 20 psi to about 120 psi.

25. The method of reducing the concentration of volatile organic compounds in water of claim 14, wherein the air-to-water ratio is from about 1 to about 150.

26. The method of reducing concentration of volatile organic compounds in water of claim 14, wherein the concentration of volatile organic compounds in the water is reduced by about 1% to about 99%.
